(19) United States
(12) Patent Application Publication
(10) Pub. No.: US 2018/0100037 A1
(43) Pub. Date: Apr. 12, 2018

(54) COPOLYMERIZATION OF ELEMENTAL SULFUR AND EPOXY FUNCTIONAL STYRENICS

(71) Applicant: ARIZONA BOARD OF REGENTS ON BEHALF OF THE UNIVERSITY OF ARIZONA, Tucson, AZ (US)

(72) Inventor: Dong-Chul Pyun, Tucson, AZ (US)

(21) Appl. No.: 15/839,344

(22) Filed: Dec. 12, 2017

Related U.S. Application Data
(63) Continuation-in-part of application No. PCT/US16/42057, filed on Jul. 13, 2016.
(60) Provisional application No. 62/433,050, filed on Dec. 12, 2016.
(60) Provisional application No. 62/191,760, filed on Jul. 13, 2015.
(60) Provisional application No. 62/203,525, filed on Aug. 11, 2015.
(60) Provisional application No. 62/210,170, filed on Aug. 26, 2015.
(60) Provisional application No. 62/212,188, filed on Aug. 31, 2015.
(60) Provisional application No. 62/306,865, filed on Mar. 11, 2016.
(60) Provisional application No. 62/313,010, filed on Mar. 24, 2016.
(60) Provisional application No. 62/329,402, filed on Apr. 29, 2016.

(51) Int. Cl. C08G 75/16; C08K 3/04; H01M 10/0525; H01M 4/60; H01M 4/62; G02B 1/04

(52) U.S. Cl. CPC C08G 75/16; C08K 3/04; G02B 1/04; H01M 4/606; H01M 4/625; H01M 10/0525

(57) ABSTRACT

Sulfur copolymers and methods of synthesizing said sulfur copolymers are described herein. Elemental sulfur is melted to form liquid sulfur monomers having reactive sulfur groups. Epoxy-functionalized styrenic comonomers having an epoxide moiety and a vinylic moiety are added to the liquid sulfur monomers. The reactive sulfur groups of the liquid sulfur monomers copolymerize with the epoxide or vinylic moiety of the epoxy-functionalized styrenic comonomers to form a crosslinked network of the sulfur copolymer.

### CROSS REFERENCE

This application is a non-provisional and claims benefit of U.S. Provisional Patent Application No. 62/433,050 filed Dec. 12, 2016, the specification(s) of which is/are incorporated herein in their entirety by reference.

This application is a continuation-in-part and claims benefit of PCT Patent Application No. PCT/US16/42057 filed Jul. 13, 2016, which claims benefit of U.S. Provisional Patent Application No. 62/191,760 filed Jul. 13, 2015, U.S. Provisional Patent Application No. 62/203,525 filed Aug. 11, 2015, U.S. Provisional Patent Application No. 62/210,170 filed Aug. 26, 2015, U.S. Provisional Patent Application No. 62/212,188 filed Aug. 31, 2015, U.S. Provisional Patent Application No. 62/306,865 filed Mar. 11, 2016, U.S. Provisional Patent Application No. 62/313,010 filed Mar. 24, 2016, and U.S. Provisional Patent Application No. 62/329,402 filed Apr. 29, 2016, the specification(s) of which is/are incorporated herein in their entirety by reference.

### GOVERNMENT SUPPORT

This invention was made with government support under Grant No. CHE1305773 awarded by NSF. The government has certain rights in the invention.

### FIELD OF THE INVENTION

The present invention relates to compositions and methods of synthesizing sulfur copolymers from elemental sulfur and epoxy functional styrenics. In particular, the sulfur copolymers described herein can have improved thermomechanical properties.

### BACKGROUND OF THE INVENTION

An incredible abundance of elemental sulfur, nearly 7-million tons is generated as a waste byproduct from hydrodesulfurization of crude petroleum feedstocks, which converts alkanethiols and other (organo) sulfur compounds into S₈. Before the invention of the inverse vulcanization process, there were only a limited number of synthetic methods available to utilize and modify elemental sulfur. Current industrial utilization of elemental sulfur is centered around sulfuric acid, agrochemicals, and vulcanization of rubber. For example, elemental sulfur is used primarily for sulfuric acid and ammonium phosphate fertilizers, where the rest of the excess sulfur is stored as megaton-sized, above ground sulfur towers.

While sulfur feedstocks are plentiful, sulfur is difficult to process. In its original form, elemental sulfur consists of a cyclic molecule having the chemical formulation S₈. Elemental sulfur is a brittle, intractable, crystalline solid having poor solid state mechanical properties, poor solution processing characteristics, and there is a limited slate of synthetic methodologies developed for it. Hence, there is a need for the production of new materials that offers significant environmental and public health benefits to mitigate the storage of excess sulfur in powder, or brick form.

Elemental sulfur has been explored for use in lithium-sulfur electrochemical cells. Sulfur can oxidize lithium when configured appropriately in an electrochemical cell, and is known to be a very high energy-density cathode material. The poor electrical and electrochemical properties of pure elemental sulfur, such as low cycle stability and poor conductivity) have limited the development of this technology. For example, one key limitation of lithium-sulfur technology is the ability to retain high charge capacity for extended numbers of charge-discharge cycles (“cycle lifetimes”). Cells based on present lithium ion technology has low capacity (180 mAh/g) but can be cycled for 500-1000 cycles. Lithium-sulfur cells based on elemental sulfur have very high initial charge capacity (in excess of 1200 mAh/g, but their capacity drops to below 400 mAh/g within the first 100-500 cycles. Hence, the creation of novel polymer materials from elemental sulfur feedstocks would be tremendously beneficial in improving sustainability and energy practices. In particular, improved battery technology and materials that can extend cycle lifetimes while retaining reasonable charge capacity will significantly impact the energy and transportation sectors and further mitigate US dependence on fossil fuels.

Previous sulfur copolymers that have been synthesized, such as those described in U.S. Pat. No. 9,306,218 and U.S. Pat. No. 9,567,439 of Pyun, the contents of which are incorporated herein by reference in their entirety, exhibit poor thermomechanical properties despite having outstanding electrochemical and optical properties. The poor thermomechanical properties of these materials hold back the translation of these materials to the polymer industry. Hence, there is a need for sulfur copolymers that have improved thermomechanical properties.

The present invention features a novel and unexpected polymerization-crosslinking reaction that also creates new sulfur plastics that retain the useful electrochemical/optical properties of earlier sulfur plastics, coupled with improved thermomechanical properties.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY OF THE INVENTION

It is an objective of the present invention to provide for sulfur copolymers that have crosslinked sulfur copolymer networks with useful electrochemical and optical properties and improved thermomechanical properties, and methods of making said sulfur copolymers. Embodiments of the invention are given in the dependent claims. Embodiments of the present invention can be freely combined with each other if they are not mutually exclusive.

The subject disclosure features the copolymerization elemental sulfur with epoxy-functional styrenic comonomers to prepare sulfur copolymers having improved thermomechanical properties. This approach is advantageous because the epoxy functional styrenic comonomers are readily accessible and offer an unexpected and novel polymerization mechanism to form cross-linked sulfur copolymers, which has not been previously observed nor utilized.

As known to one of ordinary skill in the art, epoxide groups do not typically react with sulfur radicals. For example, the crosslinking and polymerization of the epoxide groups typically require the addition of a photoinitiator/catalyst or base to promote these reactions. Hence, the inventors initially strived to make a sulfur copolymer that was a soluble, non-crosslinked polymer fluid carrying reactive epoxide side chain groups.

However, the inventors have surprisingly discovered a novel polymerization reaction in which rigid, crosslinked sulfur polymer networks were formed from a single heating step of liquid sulfur and epoxy functional styrenics, such as 4-vinylbenzyl glycidyl ether or 4-epoxystyrene (also named 2-(4-vinylphenyl)oxirane)). Direct copolymerization of liquid sulfur (via inverse vulcanization), or polysulfides like poly(styrene-random-sulfur) (via dynamic covalent polymerization) was unexpected. When heating liquid sulfur, reactive sulfur intermediates such as sulfur radicals and anions may be generated in the same medium. The liquid sulfur and inverse vulcanization process can proceed via reactivity of sulfur radicals generated from liquid sulfur undergoing thiol-ene addition to vinylic moieties. Oxiranes and epoxides can be ring-opened by neutral nucleophiles, or anionically by nucleophilic anions (e.g., alkoxides or thiolates which are sulfur anionic species). None of the presently known prior references or works has this unique inventive technical feature of the present invention.

Further still, sulfur copolymers, such as poly(sulfur-random-(1,3-diisopropenyl-benzene), can have low glass transition temperatures of around 0-30° C. as determined from Differential Scanning Calorimetry (DSC). As known to one of ordinary skill in the art, the glass transition temperature of a polymer is defined as the temperature of when the polymer goes from an amorphous rigid state to a more flexible state (i.e. rubbery), under ambient conditions. The novel sulfur copolymers of the present invention exhibit glass transition temperatures exceeding 50° C. as determined from DSC, which, in reality, may be significantly higher since DSC tends to underestimate these glass transition values. None of the presently known prior references or work has this unique inventive technical feature of the present invention.

### BRIEF DESCRIPTION OF THE DRAWINGS

The features and advantages of the present invention will become apparent from a consideration of the following detailed description presented in connection with the accompanying drawings in which:

FIG. 1 shows a non-limiting embodiment of the present invention where elemental sulfur is reacted with 4-vinylbenzyl glycidyl ether to form a sulfur copolymer.

FIG. 2 shows another non-limiting embodiment of the present invention where elemental sulfur is reacted with 2-(4-vinylphenyl)oxirane (VPO) to form a sulfur copolymer.

FIG. 3 shows an NMR spectral comparison of VPO (bottom), a sulfur copolymer product of elemental sulfur and VPO after 30 minutes of heating (middle), and the sulfur copolymer product after 5 hours of heating (top).

### DESCRIPTION OF PREFERRED EMBODIMENTS

As used herein, sulfur can be provided as elemental sulfur, for example, in powdered form. Under ambient conditions, elemental sulfur primarily exists in an eight-membered ring form (S₈) which melts at temperatures in the range of 120° C.-130° C. and undergoes an equilibrium ring-opening polymerization (ROP) of the S₈ monomer into a linear polysulfane with diradical chain ends. As the person of skill in the art will appreciate, while S is generally the most stable, most accessible and cheapest feedstock, many other allotropes of sulfur can be used (such as other cyclic allotropes, derivable by melt-thermal processing of Se). Any sulfur species that yield diradical or anionic polymerizing species when heated as described herein can be used in practicing the present invention.

As used herein, the term “sulfur polymer” generally refers to any polymer or copolymer that contains sulfur monomers. In some embodiments, the sulfur monomers may be derived from elemental sulfur (Se). The term “sulfur polymer” may be used interchangeably with sulfur copolymer, sulfur polymer composition, or sulfur terpolymer, unless specified otherwise.

As used herein, the term “functional” in correlation with a polymer refers to functional polymers that have specified physical, chemical, biological, pharmacological, or other properties or uses that are determined by the presence of specific chemical functional groups, which are usually dissimilar to those of the backbone chain of the polymer.

As known to one of ordinary skill in the art, a styrene is a derivative of benzene ring that has a vinylic moiety. As used herein, a “styrenic comonomer” is a monomer comprised of a benzene with a vinylic functional group. In some embodiments, the vinylic functional group of the styrenic comonomer is the moiety that participates in a reaction. In some embodiments, the sulfur diradicals can link to the vinylic moieties of the styrenic commoners to form the sulfur-styrenic polymer. In further embodiments, the styrenic comonomer may comprise at least one other reactive functional group, such as another vinyl or an epoxide moiety. In other embodiments, the reactive functional group may be a halogen, an alkyl halide, an alkyl, an alkoxy, an amine, or a nitro functional group. Non-limiting examples of styrenic comonomers include bromostyrene, chlorostyrene, (trifluoromethyl)styrene, fluorostyrene, vinylaniline, acetoxystyrene, methoxystyrene, ethoxystyrene, methylstyrene, nitrostyrene, vinylbenzoic acid, vinylanisole, and vinylbenzyl chloride.

As used herein, the term “epoxide monomer” is a monomer that has epoxide functional groups. Non-limiting examples of such monomers include, generally, mono- or polyoxiranylbenzenes, mono- or polyglycidylbenzenes, mono- or polyglycidyloxybenzenes, mono- or polyoxiranyl(hetero)aromatic compounds, mono- or polyglycidyl(hetero)aromatic compounds, mono- or polyglycidyloxy(hetero)aromatic compounds, diglycidyl bisphenol A ethers, mono- or polyglycidyl(cyclo)alkyl ethers, mono- or polyepoxy(cyclo)alkane compounds and oxirane-terminated oligomers. In one preferred embodiment, the epoxide monomers may be benzyl glycidyl ether and tris(4-hydroxyphenyl)methane triglycidyl ether. In certain embodiments, the epoxide monomers may include a (hetero)aromatic moiety such as, for example, a phenyl, a pyridine, a triazine, a pyrene, a naphthalene, or a polycyclic (hetero)aromatic ring system, bearing one or more epoxide groups. For example, in certain embodiments, the one or more epoxide monomers are selected from epoxy(hetero)aromatic compounds, such as styrene oxide and stilbene oxide and (hetero)aromatic glycidyl compounds, such as glycidyl phenyl ethers (e.g., resorcinol diglycidyl ether, glycidyl 2-methylphenyl ether), glycidylbenzenes (e.g., (2,3-epoxypropyl)benzene) and glycidyl heteroaromatic compounds (e.g., N-(2,3-epoxypropyl)phthalimide). In other embodiments, the epoxide monomer is a glycidol. In certain desirable embodiments, an epoxide monomer may have a boiling point greater than 180° C., greater than 200° C., or even greater than 230° C. at the pressure at which polymerization is performed (e.g., at standard pressure, or at other pressures).

As previously described, the styrenic comonomer may further comprise at least one other reactive functional group, in addition to the vinyl moiety. For instance, an epoxy-functionalized styrenic comonomer is defined as a styrenic comonomer having at least one epoxy functional group.

As used herein, the term “amine monomer” is a monomer that has an amine functional group. In one embodiment, aromatic amines and multi-functional amines may be used. Amine monomers include, but are not limited to, aromatic amines, vinylaniline, m-phenylenediamine, and p-phenylenediamine. The various types of phenylenediamines are inexpensive reagents due to their wide-spread use in the preparation of many conventional polymers, e.g., polyureas, polyamides.

As used herein, the term “thiol monomer” is a monomer that has a thiol functional group. Thiol monomers include, but are not limited to, 4,4′-thiobisbenzenethiol and the like. The term “sulfide monomers” are monomers that have sulfide functional groups.

As used herein, an alkynylly unsaturated monomer is a monomer that has an alkynylly unsaturated functional group (i.e. triple bond). The term “alkynylly unsaturated monomer” does not include compounds in which the alkynyl unsaturation is part of a long chain alkyl moiety (e.g., unsaturated fatty acids, or carboxylic salts, or esters such as oleates, and unsaturated plant oils). In one embodiment, aromatic alkynes, both internal and terminal alkynes, multi-functional alkynes may be used. Examples of alkynylly unsaturated monomers include, but are not limited to, ethynylbenzene, 1-phenylpropyne, 1,2-diphenylethyne, 1,4-diethynylbenzene, 1,4-bis(phenylethynyl)-benzene, and 1,4-diphenylbuta-1,3-diyne.

As used herein, the term “nitrone monomer” is a monomer that has a nitrone groups. In one embodiment, nitrones, dinitrones, and multi-nitrones may be used. Examples include, but are not limited to, N-benzylidene-2-methylpropan-2-amine oxide.

As used herein, an “aldehyde monomer” is a monomer that has an aldehyde functional group. In one embodiment, aldehydes, dialdehydes, and multi-aldehydes may be used.

As used herein, the term “ketone monomer” is a monomer that has a ketone functional group. In one embodiment, ketones, di-ketones, and multi-ketones may be used.

As used herein, the term “thiirane monomer” is a monomer that has a thirane functional group. Non-limiting examples of thiirane monomers include, generally, mono- or polythiiranylbenzenes, mono- or polythiiranylmethylbenzenes, mono- or polythiiranyl(hetero)aromatic compounds, mono- or polythiiranylmethyl(hetero)-aromatic compounds, dithiiranylmethyl bisphenol A ethers, mono- or polydithiiranyl (cyclo)alkyl ethers, mono- or polyepisulfide(cyclo)alkane compounds, and thiirane-terminated oligomers. In some embodiments, thiirane monomers may include a (hetero)aromatic moiety such as, for example, a phenyl, a pyridine, a triazine, a pyrene, a naphthalene, or a poly cyclic (hetero)aromatic ring system, bearing one or more thiirane groups. In certain desirable embodiments, a thiirane monomer can have a boiling point greater than 180° C., greater than 200° C., or even greater than 230° C. at the pressure at which polymerization is performed (e.g., at standard pressure).

As used herein, an ethylenically unsaturated monomer is a monomer that contains an ethylenically unsaturated functional group (i.e. double bond). The term “ethylenically unsaturated” may be used interchangeably with the term “unsaturated”. One of ordinary skill in the art will undertand that “unsaturated” refers to the C═C functional group. The term “ethylenically unsaturated monomer” does not include compounds in which the ethylenic unsaturation is part of a long chain alkyl moiety (e.g. unsaturated fatty acids such as oleates, and unsaturated plant oils).

Non-limiting examples of ethylenically unsaturated monomers include vinyl monomers, acryl monomers, (meth)acryl monomers, unsaturated hydrocarbon monomers, and ethylenically-terminated oligomers. Examples of such monomers include, generally, mono- or polyvinylbenzenes, mono- or polyisopropenylbenzenes, mono- or polyvinyl(hetero)aromatic compounds, mono- or polyisopropenyl(hetero)-aromatic compounds, acrylates, methacrylates, alkylene di(meth)acrylates, bisphenol A di(meth)acrylates, benzyl (meth)acrylates, phenyl(meth)acrylates, heteroaryl (meth)acrylates, terpenes (e.g., squalene) and carotene. In some embodiments, non-limiting examples of ethylenically unsaturated monomers that are non-homopolymerizing include allylic monomers, isopropenyls, maleimides, norbornenes, vinyl ethers, and methacrylonitrile. In other embodiments, the ethylenically unsaturated monomers may include a (hetero)aromatic moiety such as, for example, phenyl, pyridine, triazine, pyrene, naphthalene, or a polycyclic (hetero)aromatic ring system, bearing one or more vinylic, acrylic or methacrylic substituents. Examples of such monomers include benzyl (meth)acrylates, phenyl (meth)acrylates, divinylbenzenes (e.g., 1,3-divinylbenzene, 1,4-divinylbenzene), isopropenylbenzene, styrenics (e.g., styrene, 4-methylstyrene, 4-chlorostyrene, 2,6-dichlorostyrene, 4-vinylbenzyl chloride), diisopropenylbenzenes (e.g., 1,3-diisopropenylbenzene), vinylpyridines (e.g., 2-vinylpyridine, 4-vinylpyridine), 2,4,6-tris((4-vinylbenzyl)thio)-1,3,5-triazine and divinylpyridines (e.g., 2,5-divinylpyridine). In certain embodiments, the ethylenically unsaturated monomers (e.g., including an aromatic moiety) bear an amino (i.e., primary or secondary) group, a phosphine group or a thiol group. One example of such a monomer is vinyldiphenylphosphine. In certain desirable embodiments, an ethylenically unsaturated monomer will have a boiling point greater than 180° C., greater than 200° C., or even greater than 230° C. at the pressure at which polymerization is performed (e.g., at standard pressure).

As used herein, an “elemental carbon material” is a material that is primarily formed as an allotrope of carbon, with a minor amount of chemical modification. For example, graphene, graphene oxide, graphite, carbon nanotubes, fullerenes, carbon black, carbon flakes and carbon fibers are examples of elemental carbon materials. As a general guideline for the person of skill in the art, elemental carbon material can be dispersed in sulfur at temperatures high enough such that the sulfur is molten, but low enough that significant ring opening and polysulfide polymerization does not occur (e.g., at temperatures in the range of about 120° C. to about 160° C.). Higher loadings of elemental carbon materials in sulfur can be achieved by pre-dissolution of the sulfur and dispersion of the elemental carbon material into a suitable solvent (e.g., carbon disulfide) followed by removal of the solvent under reduced pressure to yield a blended composite powder. To induce curing of the dispersed carbon, or other nanoinclusions with the sulfur matrix, direct heating of the dispersion to above 160° C. but typically below 200° C. can afford a polymerized nanocomposite.

As used herein, the terms “those defined above” and “those defined herein” when referring to a variable incorporates by reference the broad definition of the variable as well as any narrow and/or preferred definitions, if any.

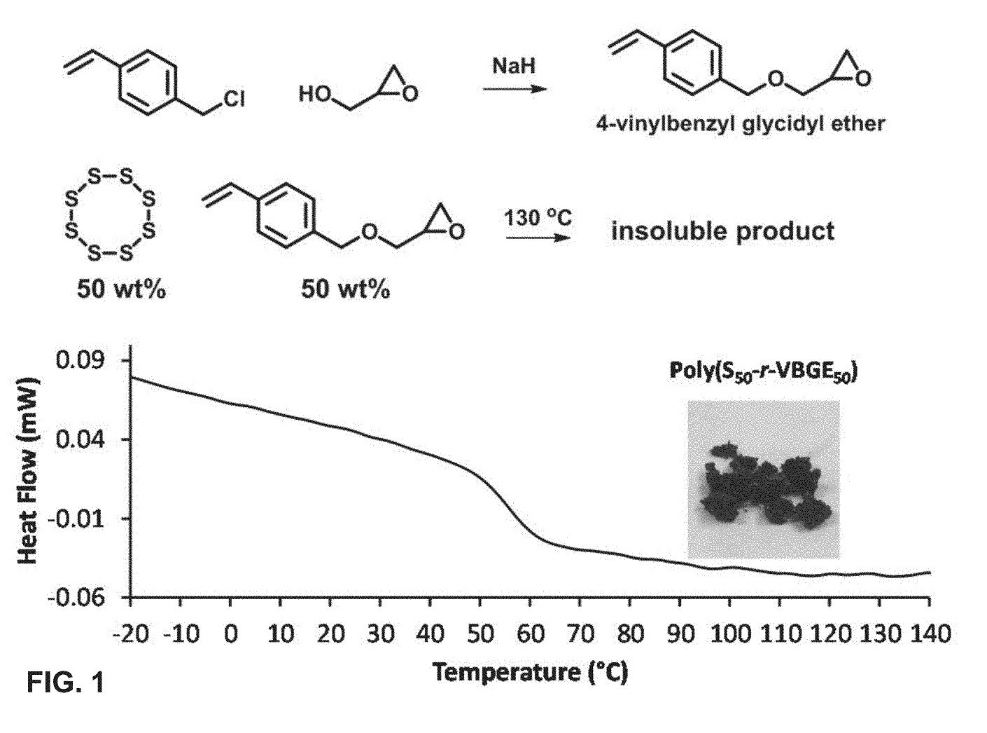

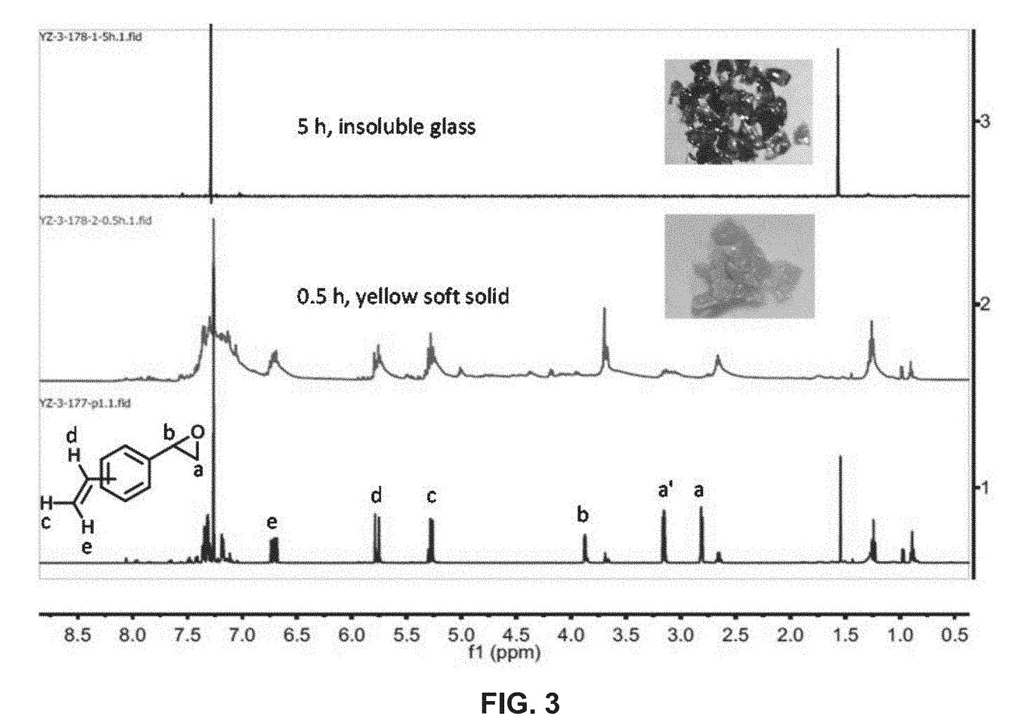

Referring now to FIG. 1-3, in some embodiments, the present invention features a method of synthesizing a sulfur copolymer. The method may comprise providing elemental sulfur, melting the elemental sulfur to form liquid sulfur monomers having reactive sulfur groups, providing one or more epoxy-functionalized styrenic comonomers having an epoxide moiety and a vinylic moiety, and adding the comonomers to the liquid sulfur monomers. Without wishing to limit the invention to a particular theory or mechanism, the reactive sulfur groups of the liquid sulfur monomers can copolymerize with the epoxide or vinylic moiety of the epoxy-functionalized styrenic comonomers to form a crosslinked network of the sulfur copolymer.

In some embodiments, the sulfur copolymer may be an insoluble polymer. In other embodiments, the sulfur copolymer may be a thermoset. In some embodiments, a glass transition temperature of the sulfur copolymer may be at least about 50° C.

In some embodiments, at least about 50 wt % of elemental sulfur is provided. In other embodiments, about 50-60 wt % of elemental sulfur is provided. In still other embodiments, about 60-70 wt %, or about 70-80 wt %, or about 80-90 wt %, or about 90-95 wt % of elemental sulfur is provided.

In some embodiments, about 5-50 wt % of epoxy-functionalized styrenic comonomers are provided. In other embodiments, about 5-15 wt % of epoxy-functionalized styrenic comonomers are provided. In still other embodiments, about 10-20 wt %, or about 20-30 wt %, or about 30-40 wt %, or about 40-50 wt % of epoxy-functionalized styrenic comonomers are provided.

In some embodiments, the step of providing one or more epoxy-functionalized styrenic comonomers may comprise providing styrenic monomers, and reacting the styrenic monomers with a compound capable of forming or adding an epoxide moiety to the styrenic monomer while maintaining a vinylic group of the styrenic monomer, thus forming epoxy-functionalized styrenic comonomers. Examples of providing one or more epoxy-functionalized styrenic comonomers are described later herein. In non-limiting embodiments, the epoxy-functionalized styrenic comonomers may be 4-vinylbenzyl glycidyl ether or 2-(4-vinylphenyl)oxirane).

In some embodiments, the reactive sulfur groups of the liquid sulfur monomers may comprise sulfur radicals and sulfur anionic species. In one embodiment, the vinylic moiety of the epoxy-functionalized styrenic comonomers can react with the sulfur radicals via a thiol-ene reaction. In another embodiment, the epoxide moiety of the epoxy-functionalized styrenic comonomers can react with the sulfur radicals or sulfur anionic species via ring-opening polymerization. Without wishing to limit the invention to a particular theory or mechanism, oxiranes and epoxides may be ring-opened by neutral nucleophiles, or anionically by nucleophilic anions such as by alkoxides or thiolates, which are sulfur anionic species. This direct copolymerization of liquid sulfur monomers (via inverse vulcanization), or polysulfides such as poly(styrene-random-sulfur) (via dynamic covalent polymerization) is unexpected, and advantageously provides a novel polymerization pathway to make new sulfur copolymers.

In some embodiments, the elemental sulfur is heated to a temperature of about 120° C. to 135° C. to melt and form the liquid sulfur monomers. After the comonomers are added, the mixture of liquid sulfur monomer and comonomers may be mixed and continuously heated for a period of time ranging from about 30 minutes to 6 hours. During this time, the liquid sulfur monomer and comonomers can be polymerizing and forming cross-links. In some embodiments, the sulfur copolymer may be in the form of an insoluble product or glassy solid.

In further embodiments, the method may further comprise reacting the sulfur copolymer with one or more termonomers to form a sulfur terpolymer. The technique of reacting can be oxidative coupling, free radical polymerization, or copolymerization. In some embodiments, the termonomers may be vinyl monomers, isopropenyl monomers, acryl monomers, methacryl monomers, unsaturated hydrocarbon monomers, epoxide monomers, thiirane monomers, alkynyl monomers, diene monomers, butadiene monomers, isoprene monomers, norbornene monomers, amine monomers, thiol monomers, sulfide monomers, alkynylly unsaturated monomers, nitrone monomers, aldehyde monomers, ketone monomers, ethylenically unsaturated, or combinations thereof. In some embodiments, the termonomers are about 5-50 wt % of the sulfur terpolymer. In other embodiments, the termonomers are about 5-15 wt %, or about 10-20 wt %, or about 20-30 wt %, or about 30-40 wt %, or about 40-50 wt % of the sulfur terpolymer.

In some embodiments, the liquid sulfur comprises dynamic sulfur-sulfur (S—S) bonds. The dynamic S—S bonds can be broken by heating to form the sulfur radicals that can copolymerize with the comonomers. In one embodiment, the elemental sulfur is melted at a temperature of about 120-140° C. For instance, the elemental sulfur is melted at a temperature of about 130° C. As used herein, the term “dynamic” is defined reversibly breaking of bonds. The introduction of S—S bonds into an intractable polymer material, or cross-linked polymer network, can allow for re-processing of the polymer material due to dynamic breaking of S—S bonds. In one embodiment, the sulfur polymers described herein are dynamic covalent polymers. The dynamic covalent polymers may comprise S—S bonds and some other polymer segment that is intractable, or cross-linked. Stimuli, such as thermal, light, or another form of stimuli, can induce dynamic activation of S—S bonds to enable re-processing, or melt processing of otherwise non-reversible, processable polymeric materials.

According to another embodiment, the present invention features a sulfur copolymer comprising a copolymerized product of at least about 50 wt % of sulfur monomers derived from elemental sulfur, and about 5-50 wt % of epoxy-functionalized styrenic comonomers having with an epoxide moiety and a vinylic moiety. Without wishing to limit the invention to a particular theory or mechanism, the copolymerization of the sulfur monomers with the epoxide or vinylic moiety of the epoxy-functionalized styrenic comonomers forms a crosslinked network of the sulfur copolymer.

In one embodiment, the sulfur copolymer may be an insoluble polymer. In another embodiment, the sulfur copolymer may be a thermoset. In some embodiments, a glass transition temperature of the sulfur copolymer may be at least about 50° C. In other embodiments, the sulfur monomers may comprise S—S bonds that, when broken, are capable of being reconnected by thermal reforming.

In some embodiments, the sulfur copolymer may comprise about 50-60 wt % of sulfur monomers. In other embodiments, the sulfur copolymer may comprise about 60-70 wt %, or about 70-80 wt %, or about 80-90 wt %, or about 90-95 wt % of sulfur monomers.

In some embodiments, the sulfur copolymer may comprise about 5-15 wt % of epoxy-functionalized styrenic comonomers. In other embodiments, the sulfur copolymer may comprise about 10-20 wt %, or about 20-30 wt %, or about 30-40 wt %, or about 40-50 wt % of epoxy-functionalized styrenic comonomers. Non-limiting examples of the epoxy-functionalized styrenic comonomers include 4-vinylbenzyl glycidyl ether or 2-(4-vinylphenyl)oxirane).

Consistent with previous embodiments, the sulfur copolymer may further comprise an elemental carbon material dispersed in the sulfur copolymer at a level in the range of up to about 50 wt % of the sulfur copolymer. For example, the carbon material is at most about 5 wt %, or at most about 10 wt %, or at most about 20 wt %, or at most about 30 wt %, or at most about 40 wt %, or at most about 50 wt % of the sulfur polymer.

In further embodiments, the sulfur copolymer may further comprise about 5 to 50 wt % of one or more termonomers. For instance, the one or more termonomers are at a level of about 5 to about 10 wt %, or about 10 to about 20 wt %, or about 20 to about 30 wt %, or about 30 to about 40 wt %, or about 40 to about 50 wt % of the sulfur polymer. In some embodiments, the termonomers may be vinyl monomers, isopropenyl monomers, acryl monomers, methacryl monomers, unsaturated hydrocarbon monomers, epoxide monomers, thiirane monomers, alkynyl monomers, diene monomers, butadiene monomers, isoprene monomers, norbornene monomers, amine monomers, thiol monomers, sulfide monomers, alkynylly unsaturated monomers, nitrone monomers, aldehyde monomers, ketone monomers, ethylenically unsaturated, or combinations thereof.

Consistent with previous embodiments, the copolymerization of the sulfur monomers with the comonomers can occur via a thiol-ene reaction or other related processes. For example, a sulfur radical can react with a C═C double bond of the comonomer. In other embodiments, the epoxide moiety of the epoxy-functionalized styrenic comonomers can copolymerize with the sulfur monomers via ring-opening polymerization by neutral nucleophiles, or anionically by nucleophilic anions such as alkoxides or thiolates (the sulfur anionic species).

Examples of polymerization techniques that may be used in accordance with the present invention include, but are not limited to, free radical polymerization, controlled radical polymerization, ring-opening polymerization, ring-opening metathesis polymerization, step-growth polymerization, and chain-growth polymerization. When polymerizing the elemental sulfur with the comonomers, a functional sulfur moiety of the elemental sulfur can bond with at least one functional moiety, i.e. the alkene moiety or epoxide moiety, of the comonomers.

A person of skill in the art will select conditions that provide the desired level of polymerization. In certain embodiments, the polymerization reaction is performed under ambient pressure. However, in other embodiments, the polymerization reaction can be performed at elevated pressure (e.g., in a bomb or an autoclave). Elevated pressures can be used to polymerize more volatile comonomers, so that they do not vaporize under the elevated temperature reaction conditions.

### EXAMPLES

The following are non-limiting examples of preparing the sulfur copolymers to demonstrate the present invention in practice. It is understood that the present invention is not limited by said examples, and that equivalents or substitutes are within the scope of the invention.

### Example 1A: Preparation of 4-Vinylbenzyl Glycidyl Ether

Referring to FIG. 1, to sodium hydride (4.0 g, 166 mmol) suspended in DMF (200 mL), glycidol (6.6 mL, 97 mmol) was added at 0° C. After the reaction mixture was stirred for 30 min at 0° C., vinyl benzyl chloride (7 mL, 50 mmol) was added and the mixture was stirred overnight at room temperature. Saturated aqueous ammonium chloride was added to quench the reaction and the aqueous layer was extracted with diethyl ether. The combined organic layers were dried over sodium sulfate and the solvent was removed in vacuo. The residue was purified by flash chromatography over silica gel (dichloromethane-hexanes 1:2 v/v)) to afford 4-vinylbenzyl glycidyl ether (6.2 g, 64%).

### Example 1B: Sulfur-4-Vinylbenzyl Glycidyl Ether Copolymerization

Agan, referring to FIG. 1, elemental sulfur (500 mg, 1.95 mmol) was added to a 4 mL glass vial equipped with a magnetic stir bar and heated at 130° C. until a clear yellow molten phase was formed. 4-vinylbenzyl glycidyl ether (500 mg, 2.57 mmol) was injected to liquid sulfur via syringe. The reaction mixture was stirred at 130° C. for 20 min yielding a dark brown glass.

### Example 2A: Preparation of 4-Epoxystyrene

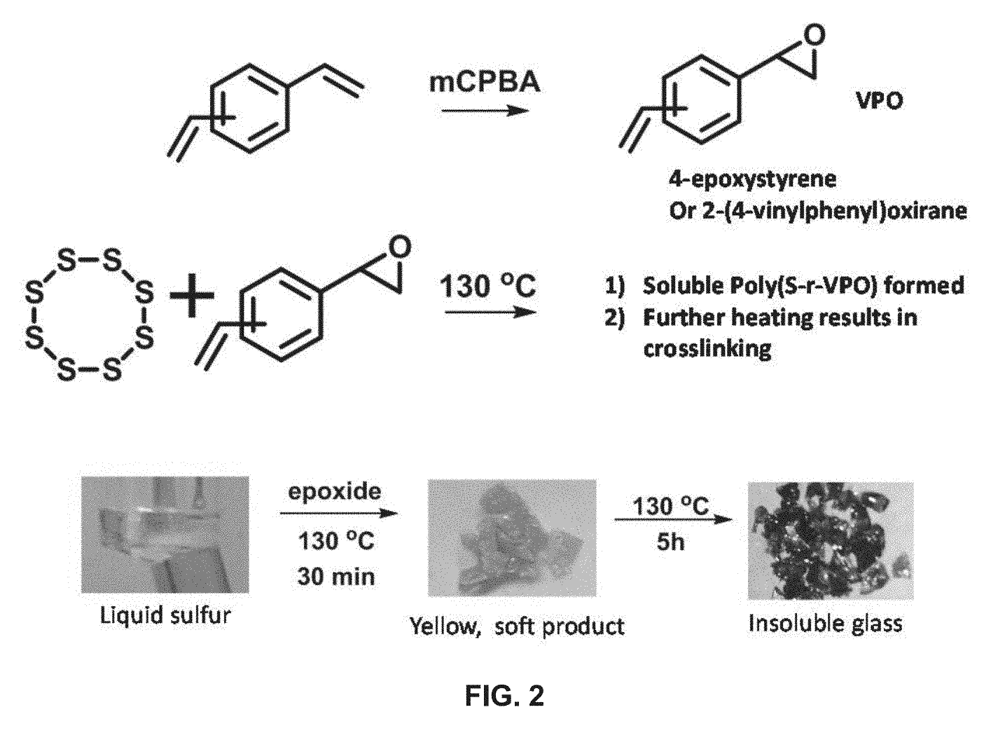

Referring to FIG. 2, one of ordinary skill in the art will understand that when an alkene is added to mCPBA, an epoxidation reaction of the alkenes occurs to form an epoxide. For instance, divinylbenzene (10 mL, 70 mmol) was added to a stirred solution of meta-chloroperbenzoic acid (mCPBA) (12 g, 70 mmol) in 100 mL of dichloromethane at 0° C. The reaction mixture was stirred overnight at room temperature. Afterwards, the reaction mixture was filtered and the organic layer was concentrated under reduced pressure. The concentrated reaction mixture was diluted with saturated NaHCO₃ solution (200 mL) and extracted with diethyl ether (50 mL×3). The combined organic layers were dried over Na₂SO₄ and filtered. The solvents were evaporated under reduced pressure. The residue was purified by flash chromatography over silica gel (dichloromethane-hexanes 1:3 v/v) and a 3.2 g light yellow oil (22 mmol, 31%) was got.

### Example 2B: Sulfur-4-Epoxystyrene Copolymerization

Elemental sulfur (500 mg, 1.95 mmol) was added to a 4 mL glass vail equipped with a magnetic stir bar and heated at 130° C. until a clear yellow molten phase was formed. 4-epoxystyrene (500 mg, 3.42 mmol) was injected to liquid sulfur via syringe. The reaction mixture was stirred at 130° C. for 5 h yielding a dark red glass.

In other embodiments, Frechet-type benzyl ether dendrimers bearing styrenic terminal groups are miscible with liquid sulfur and can be used as polyfunctional cross-linkers. In certain embodiments, the one or more polyfunctional monomers include one or more of a divinylbenzene, a diisopropenylbenzene, an alkylene di(meth)acrylate, a bisphenol A di(meth)acrylate, a terpene, a carotene, a divinyl (hetero)aromatic compound, and a diisopropenyl (hetero)aromatic compound. In other embodiments, a polyfunctional monomer can have one or more amine, thiol, sulfide, alkynylly unsaturated, nitrone and/or nitroso, aldehyde, ketone, thiirane, ethylenically unsaturated, and/or epoxide moieties moieties; and one or more amine, thiol, sulfide, alkynylly unsaturated, nitrone and/or nitroso, aldehyde, ketone, thiirane, ethylenically unsaturated, and/or epoxide moieties, wherein the first and second moieties are different. A non-limiting example is a divinylbenzene monoxide.

Alternative embodiments of the sulfur copolymer may further comprise one or more monofunctional monomers, or one or more polyfunctional monomers (e.g., difunctional or trifunctional). The one or more polyfunctional monomers is selected from a group consisting of a polyvinyl monomer (e.g., divinyl, trivinyl), a polyisopropenyl monomer (e.g., diisoprenyl, triisoprenyl), a polyacryl monomer (e.g., diacryl, triacryl), a polymethacryl monomer (e.g., dimethacryl, trimethacryl), a polyunsaturated hydrocarbon monomer (e.g., diunsaturated, triunsaturated), a polyepoxide monomer (e.g., diepoxide, triepoxide), a polythiirane monomer (e.g., dithiirane, trithiirane), a polyalkynyl monomer, a polydiene monomer, a polybutadiene monomer, a polyisoprene monomer, a polynorbornene monomer, a polyamine monomer, a polythiol monomer, a polysulfide monomer, a polyalkynylly unsaturated monomers, a polynitrone monomers, a polyaldehyde monomers, a polyketone monomers, and a polyethylenically unsaturated monomers.

In some embodiments, the one or more polyfunctional monomers is selected from a group consisting of a divinylbenzene, a diisopropenylbenzene, an alkylene di(meth)acrylate, a bisphenol A di(meth)acrylate, a terpene, a carotene, a divinyl (hetero)aromatic compound and a diisopropenyl (hetero)aromatic compound. In other embodiments, a polyfunctional monomer can have one or more amine, thiol, sulfide, alkynylly unsaturated, nitrone and/or nitroso, aldehyde, ketone, thiirane, ethylenically unsaturated, and/or epoxide moieties moieties; and one or more amine, thiol, sulfide, alkynylly unsaturated, nitrone and/or nitroso, aldehyde, ketone, thiirane, ethylenically unsaturated, and/or epoxide moieties, wherein the first and second moieties are different. A non-limiting example is a divinylbenzene monoxide.

In some embodiments, the one or more polyfunctional monomers are at a level of about 2 to about 50 wt %, or about 2 to about 10 wt %, or about 10 to about 20 wt %, or about 20 to about 30 wt %, or about 30 to about 40 wt %, or about 40 to about 50 wt % of the sulfur polymer. In other embodiments, the one or more monofunctional monomers are at a level up to about 5 wt %, or about 10 wt %, or about 15 wt % of the sulfur polymer.

Any of the sulfur polymers describe herein may be used in preparing elastomers, resins, lubricants, coatings, antioxidants, cathode materials for electrochemical cells, and dental adhesives/restorations. For example, the sulfur polymer may be formed into a polymeric film.

According to other embodiments, the sulfur copolymers described herein may be used in an electrochemical cell, such as a lithium sulfide battery. In some embodiments, the electrochemical cell may comprise an anode comprising metallic lithium, a cathode comprising the sulfur copolymer, and an electrolyte interposed between the cathode and the anode. Without wishing to limit the invention to a particular theory or mechanism, the sulfur copolymer can generate soluble additive species in situ upon discharge that may be co-deposited with lower sulfide discharge products onto the cathode by an electrochemical reaction or a non-electrochemical reaction. In some embodiments, the lower sulfide discharge products are Li₂S₃, Li₂S₂, or Li₂S. Preferably, the electrochemical cell has an increased volumetric energy density. For example, the capacity of the electrochemical cell ranges from about 400 to about 1400 mAh/g.

These additive species may be introduced into the electroactive material during the synthesis of the material, or added to the electrolyte or battery separator as a soluble species. These additive species are able to co-deposit with sulfide-containing discharge products via active electrochemical reactions, or passive non-electrochemical processes. Co-deposition of these additive species with sulfide discharge products onto the Li—S cathode can plasticize the electrode against mechanical fracture during battery charge-discharge cycling. Plasticization enables retention of charge capacity and improve cycle lifetime beyond 100 cycles. The electroactive material in this case is best embodied by the sulfur polymers described herein. Upon discharge of this polymer, soluble organosulfur species are formed which function to improve Li—S batteries as described above.

Any embodiment of the electrochemical cells may be used in electric vehicle applications, portable consumer devices portable consumer devices (e.g., Personal electronics, cameras, electronic cigarettes, handheld game consoles, and flashlights), motorized wheelchairs, golf carts, electric bicycles, electric forklifts, tools, automobile starters, and uninterruptible power supplies.

In some embodiments, the electrolyte and/or a separator comprise the sulfur polymer. As previously described, the sulfur polymer of the electrolyte may also generate soluble organosulfur species upon discharge. The soluble additive species are co-deposited with the lower sulfide discharge products by an electrochemical reaction or a non-electrochemical reaction.

In certain embodiments, it can be desirable to use a nucleophilic viscosity modifier in liquefying the elemental sulfur, for example, before adding the comonomers. For example, in certain embodiments, the elemental sulfur is first heated with a viscosity modifier, then the viscosity-modified elemental sulfur is heated with the comonomers. The nucleophilic viscosity modifier can be, for example, a phosphorus nucleophile (e.g., a phosphine), a sulfur nucleophile (e.g., a thiol) or an amine nucleophile (e.g., a primary or secondary amine). When the elemental sulfur is heated in the absence of a nucleophilic viscosity modifier, the elemental sulfur ring can open to form, e.g., diradicals, which can combine to form linear polymer chains which can provide a relatively high overall viscosity to the molten material. Nucleophilic viscosity modifiers can break these linear chains into shorter lengths, thereby making shorter polymers that lower the overall viscosity of the molten material, making the elemental sulfur mixture easier to mix with and other species, and easier to stir for efficient processing.

Some of the nucleophilic viscosity modifier may react and be retained as a covalently bound part of the polymer, and some will react to form separate molecular species, with the relative amounts depending on nucleophile identity and reaction conditions. While some of the nucleophilic viscosity modifier may end up as a separate molecular species from the polymer chain, as used herein, nucleophilic viscosity modifiers may become part of the polymer. Non-limiting examples of nucleophilic viscosity modifiers include triphenylphosphine, aniline, benzenethiol, and N,N-dimethylaminopyridine. Nucleophilic viscosity modifiers can be used, for example, in an amount up to about 10 wt %, or even up to about 5 wt % of the sulfur polymer. When a nucleophilic viscosity modifier is used, in certain embodiments it can be used in the range of about 5 wt % to about 15 wt % of the sulfur copolymer.

In certain embodiments, a monofunctional comonomer can be used to reduce the viscosity of the sulfur copolymer, for example, before adding other comonomers (e.g., before adding any polyfunctional comonomer). For example, in certain embodiments, the elemental sulfur is first heated with one or more monofunctional comonomers. While not intending to be bound by theory, the inventors surmise that inclusion of monofunctional comonomers into the poly(sulfur) chains disrupts intermolecular associations of the elemental sulfur, and thus decreases the viscosity. The monofunctional comonomer can be, for example, a mono(meth)acrylate such as benzyl methacrylate, a mono(oxirane) such as a styrene oxide or a glycidyl phenyl ether, or a mono(thiirane) such as t-butyl thiirane or phenoxymethylthiirane. A monofunctional comonomer can be used to modify the viscosity of the sulfur polymer, for example, in an amount up to about 10 wt %, up to about 5 wt %, or even up to about 2 wt % of the polymer. When a monofunctional monomer can be used to modify the viscosity of the sulfur polymer, in certain embodiments it can be used in the range of about 0.5 wt % to about 5 wt %, or even about 0.5 wt % to about 3 wt % of the sulfur polymer.

Of course, viscosity modification is not required, so in other embodiments, the elemental sulfur is heated together with the comonomers (and particularly with one or more polyfunctional comonomers) without viscosity modification. In other embodiments, a solvent, e.g., a halobenzene such as 1,2,4-trichlorobenzene, a benzyl ether, or a phenyl ether, can be used to modify the viscosity of the materials for ease of handling. The solvent can be added, for example, to the elemental sulfur or sulfur copolymers before reaction with a comonomer in order to reduce its viscosity, or to the polymerized material in order to aid in processing into a desired form factor.

In alternative embodiments, the sulfur copolymers described herein can be effectively thermoplastic in nature. A person of skill in the art will understand that methods familiar in the thermoplastic industries, such as injection molding, compression molding, and melt casting, may be used in forming articles from the materials described herein.

The sulfur copolymers described herein can be partially cured to provide a more easily processable material, which can be processed into a desired form (e.g., into a desired shape, such as in the form of a free-standing shape or a device), then fully cured in a later operation. For example, one embodiment of the invention is a method of making an article formed from the sulfur polymers as described herein. The method includes heating the sulfur polymer at a temperature in the range of about 120° C. to about 220° C. (e.g. 120° C. to about 150° C.) to form a prepolymer; forming the prepolymer into the shape of the article, to yield a formed prepolymer shape; and further heating the formed prepolymer shape to yield the article. The prepolymer can be formed, for example, by conversion of the one or more monomers at a level in the range of about 20 to about 50 mol %. For example, heating the sulfur polymer to form the prepolymer can be performed for a time in the range of about 20 seconds to about five minutes, for example, at a temperature in the range of about 175° C. to about 195° C. In one embodiment, the heating is performed for less than about 2 minutes at about 185° C. The person of skill in the art will determine the desired level of monomer conversion in the prepolymer stage to yield a processable prepolymer material, and will determine process conditions that can result in the desired level of monomer conversion.

In one embodiment, the prepolymer can be provided as a mixture with a solvent for forming, e.g., via casting, molding or printing. The prepolymers described herein can form miscible mixtures or solutions with a variety of nonpolar high-boiling aromatic solvents, including, for example, haloarene solvents such as di- and trichlorobenzene (e.g., 1,2,4-trichlorobenzene). The solvent can be added, for example, after the prepolymer is prepared, to provide a softened or flowable material suitable for a desired forming step (e.g., casting, molding, or spin-, dip- or spray-coating.) In some embodiments, the prepolymer/solvent mixture can be used at elevated temperatures (e.g., above about 100° C., above about 120° C. or above about 140° C.) to improve flow at relatively low solvent levels (e.g., for use in casting or molding processes). In other embodiments, the prepolymer/solvent mixture can be used at a lower temperature, for example, at ambient temperatures. The prepolymers described herein can remain soluble even after the solvent cools.

In one embodiment, the prepolymer is coated and cured as a film on a substrate. While S₈ is typically intractable due to its crystallinity, the materials described herein can be formed as to be amenable to solution processing (e.g., in molten or solvent-admixed form) to fabricate thin film materials. Mixtures of molten prepolymer and solvent can be diluted to the concentration desired for a given spin-coating process.

When forming thin films of the materials described herein on substrates, it can often be desirable to use a polyimide primer layer. Thus, a solution of a polyamic precursor (e.g., polypyromellitamic acid-4,4′-dianiline, or compounds with oxyaniline linkages), or similar polymer derivatives can be deposited onto a substrate and cured (e.g., by heating at a temperature in the range of about 120 to about 220° C.) to form a thin polyimide layer (e.g., as thin as 2 nm), upon which the materials described herein can be formed. Moreover, in many embodiments, even fully cured polymers as described herein can be melt-processed or suspended or dissolved in solvent and deposited on to substrates in a manner similar to those described for prepolymeric materials.

In certain embodiments, the prepolymer can be shaped and cured using a mold. For example, in one embodiment, the prepolymer (i.e., in liquid or solvent-admixed form) can be deposited (e.g., by pouring) into a TEFLON or silicone (e.g., polydimethylsiloxane (PDMS)) mold, then cured to form a desired shape. In another embodiment, a softened prepolymer material (e.g., swollen with solvent and/or softened by heat) can be imprinted by stamping with a mold bearing the desired inverse surface relief, then cured and allowed to cool. Moreover, in many embodiments, even fully cured copolymers as described herein can be shaped with a mold in a manner similar to those described for prepolymeric materials. Sulfur terpolymers and more complex polymer materials, such as in the form of cross-linked polymers, or non-crosslinked, intractable polymers, can be reprocessed by thermal or other stimuli activation of dynamic S—S bonds in the polymer system.

As described above, soluble sulfur polymers can be made by the person of skill in the art, for example, using relatively higher fractions of organic monomer(s). Such polymers can be solution processed to fabricate articles. For example, another aspect of the invention is a method of forming an article formed from a sulfur polymer as described herein, the method comprising admixing the sulfur polymer with a nonpolar organic solvent (e.g., to make a suspension or solution), forming the admixed sulfur polymer into the shape of the article, and removing the solvent from the sulfur polymer to yield the article. The admixture with solvent can, for example, dissolve the sulfur polymer. Various process steps can be performed at elevated temperatures, for example, to decrease viscosity of the admixed sulfur polymer and to aid in evaporation of solvent.

For example, in one embodiment, a room temperature solution of any sulfur polymer described herein (e.g., in prepolymeric form) is poured into a TEFLON or PDMS mold. A decrease in viscosity at elevated temperatures (e.g., >about 140° C.) can allow sufficient flow into even intricate mold shapes. Once the mold is filled, it can be placed in a vacuum oven at increased temperature (e.g., about 210° C.) under ambient pressure to cure and to drive off solvent. For thicker molded samples, vacuum can be pulled on the solution when it is in a low viscosity state in order to ensure the removal of bubbles. The mold is then removed from the oven and allowed to cool before removal from the mold.

According to other embodiments, the sulfur copolymers described herein may be used to form an optical element. In some embodiments, the sulfur copolymers may be formed as a substantially optically transparent body having a refractive index in the range of about 1.7 to about 2.6 and at least one wavelength in the range of about 500 nm to about 10 μm. For example, the optical substrate may be a substantially transparent optical body, such as a film, a lens, or a free-standing object. Preferably, the optical substrate has an optical transparency in the visible and infrared spectrum.

In some embodiments, the present invention features a method of repairing an optical substrate, said method comprising providing the optical substrate comprising any of the sulfur copolymers described herein, the sulfur copolymers having one or more broken S—S bonds, and heat treating the optical substrate at a healing temperature for a period of time in order to reconnect the S—S bonds of the sulfur copolymers. In some embodiments, the healing temperature is about 80° C. and 100° C. or alternatively, about 100° C. and 150° C. In some embodiments, the healing temperature is at or near the melting point of the polymeric substrate. In some embodiments, the period of time is between about 4 and 15 hours. In some embodiments, the period of time is between about 8 and 12 hours. For illustrative purposes, a thermal reforming procedure for a self-healing optical substrate may comprise placing an optical substrate having a crack in an oven and heating the optical substrate at a temperature of about 100° C. for about 3 hours. The optical substrate can be inspected to ensure that it is completely self-healed.

As used herein, the term “about” refers to plus or minus 10% of the referenced number.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

What is claimed is:

1. A method of synthesizing a sulfur copolymer, comprising:
a. providing elemental sulfur;
b. melting the elemental sulfur to form liquid sulfur monomers having reactive sulfur groups;
c. providing one or more epoxy-functionalized styrenic comonomers, said comonomers having an epoxide moiety and a vinylic moiety; and
d. adding the comonomers to the liquid sulfur monomers, wherein the reactive sulfur groups of the liquid sulfur monomers copolymerize with the epoxide or vinylic moiety of the epoxy-functionalized styrenic comonomers to form a crosslinked network of the sulfur copolymer.

2. The method of claim 1, wherein at least about 50 wt % of elemental sulfur is provided.

3. The method of claim 1, wherein about 5-50 wt % of epoxy-functionalized styrenic comonomers are provided.

4. The method of claim 1, wherein the epoxy-functionalized styrenic comonomers are 4-vinylbenzyl glycidyl ether or 2-(4-vinylphenyl)oxirane).

5. The method of claim 11, wherein the reactive sulfur groups comprise sulfur radicals and sulfur anionic species.

6. The method of claim 5, wherein the vinylic moiety of the epoxy-functionalized styrenic comonomers reacts with the sulfur radicals via a thiol-ene reaction.

7. The method of claim 5, wherein the epoxide moiety of the epoxy-functionalized styrenic comonomers reacts with the sulfur radicals or sulfur anionic species via ring-opening polymerization.

8. The method of claim 1, wherein the sulfur copolymer is an insoluble thermoset.

9. The method of claim 1, wherein a glass transition temperature of the sulfur copolymer is at least about 50° C.

10. The method of claim 1, further comprising dispersing an elemental carbon material in the sulfur copolymer, wherein the carbon material is at most about 50 wt % of the sulfur copolymer.

11. The method of claim 1, further comprising reacting the sulfur copolymer with one or more termonomers to form a sulfur terpolymer, wherein the termonomers are about 5-50 wt % of the sulfur terpolymer, wherein the termonomers are selected from a group consisting of a vinyl monomer, an isopropenyl monomer, an acryl monomer, a methacryl monomer, an unsaturated hydrocarbon monomer, an epoxide monomer, a thiirane monomer, an alkynyl monomer, a diene monomer, a butadiene monomer, an isoprene monomer, a norbornene monomer, an amine monomer, a thiol monomer, a sulfide monomer, an alkynylly unsaturated monomer, a nitrone monomer, an aldehyde monomer, a ketone monomer, and an ethylenically unsaturated monomer.

12. A sulfur copolymer comprising a copolymerized product of at least about 50 wt % of sulfur monomers derived from elemental sulfur, and about 5-50 wt % of epoxy-functionalized styrenic comonomers having with an epoxide moiety and a vinylic moiety, wherein copolymerization of the sulfur monomers with the epoxide or vinylic moiety of the epoxy-functionalized styrenic comonomers forms a crosslinked network of the sulfur copolymer.

13. The sulfur copolymer of claim 12, wherein the epoxy-functionalized styrenic comonomers are 4-vinylbenzyl glycidyl ether or 2-(4-vinylphenyl)oxirane).

14. The sulfur copolymer of claim 12, wherein the sulfur copolymer is an insoluble thermoset.

15. The sulfur copolymer of claim 12, wherein a glass transition temperature of the sulfur copolymer is at least about 50° C.

16. The sulfur copolymer of claim 12, wherein the sulfur monomers comprises S—S bonds that, when broken, are configured to be reconnected by thermal reforming.

17. The sulfur copolymer of claim 12, wherein the sulfur copolymer further comprises an elemental carbon material dispersed in the sulfur copolymer at a level in the range of up to about 50 wt % of the sulfur copolymer.

18. The sulfur copolymer of claim 12, further comprising about 5 to 50 wt % of one or more termonomers, wherein the termonomers are selected from a group consisting of a vinyl monomer, an isopropenyl monomer, an acryl monomer, a methacryl monomer, an unsaturated hydrocarbon monomer, an epoxide monomer, a thiirane monomer, an alkynyl monomer, a diene monomer, a butadiene monomer, an isoprene monomer, a norbornene monomer, an amine monomer, a thiol monomer, a sulfide monomer, an alkynylly unsaturated monomer, a nitrone monomer, an aldehyde monomer, a ketone monomer, and an ethylenically unsaturated monomer.

19. An optical element comprising the sulfur copolymer of claim 12 formed as a substantially optically transparent body, wherein the sulfur copolymer has a refractive index in the range of about 1.7 to about 2.2 and at least one wavelength in the range of about 300 nm to about 10 μm.

20. An electrochemical cell comprising:
a. an anode comprising metallic lithium;
b. a cathode comprising the sulfur copolymer of claim 12; and
c. an electrolyte interposed between the cathode and the anode;
wherein the sulfur copolymer generates soluble additive species in situ upon discharge, wherein the soluble additive species are co-deposited with lower sulfide discharge products onto the cathode by an electrochemical reaction or a non-electrochemical reaction.
